(19) United States
(12) Patent Application Publication
(10) Pub. No.: US 2026/0237230 A1
(43) Pub. Date: Aug. 13, 2026

(54) SYSTEM AND METHOD FOR AUTOMATED STRATIGRAPHIC ANALYSIS

(71) Applicant: BP Corporation North America Inc., Houston, TX (US)

(72) Inventors: Emily Browning, Houston, TX (US); Ruairi Dunne, London (GB); Jonathan Crouch, London (GB); David Bord, Houston, TX (US)

(73) Assignee: BP Corporation North America Inc., Houston, TX (US)

(21) Appl. No.: 19/533,784

(22) Filed: Feb. 9, 2026

Related U.S. Application Data
(60) Provisional application No. 63/756,563, filed on Feb. 10, 2025.

(51) Int. Cl. G06V 20/69; G06T 7/00; G06V 10/764

(52) U.S. Cl. CPC G06V 20/698; G06T 7/0002; G06V 10/764; G06T 2207/10056; G06T 2207/30181

(57) ABSTRACT

A method includes preparing a slide with a rock sample; and capturing, with a slide scanner, a plurality of images of the slide in a non-continuous scanning pattern until a predetermined coverage percentage of the slide is captured, where each image is a block of a predetermined block dimension. The method also includes generating a prediction for each of the images, where the prediction for an image includes an identification of a fossil of a species present in the image and a confidence level associated with the identification; filtering the images based on a confidence level threshold for the confidence level associated with the identified species; and generating a filtered set of images comprising the prediction for each image.

### CROSS-REFERENCE TO RELATED APPLICATIONS

This application is a non-provisional patent application which claims benefit of U.S. provisional patent application No. 63/756,563 filed Feb. 10, 2025, and entitled “System and Method for Automated Stratigraphic Analysis”, which is incorporated herein by reference in its entirety for all purposes.

### BACKGROUND

The field of biostratigraphy plays a role in hydrocarbon exploration and production, allowing for the determination of the relative ages of subsurface rock formations and their depositional environments. Calcareous nannofossils, microscopic fossils of marine algae, serve as biostratigraphic markers due to their distinct morphologies and evolutionary patterns.

Conventionally, biostratigraphic analysis has relied on manual microscopic examination and identification of these nannofossils by highly trained specialists. This manual process, while effective, is time-consuming, labor-intensive, and subject to inter-observer variability. The scarcity of experienced specialists further compounds these challenges, potentially creating bottlenecks in project timelines and impeding efficient decision-making.

Advancements in automated microscopy and machine learning have opened up new possibilities for improving biostratigraphic workflows. High-throughput slide scanning systems, capable of capturing thousands of images per slide, have increased the speed and efficiency of data acquisition. Machine learning models, trained on relatively large datasets of labeled images, offer the potential to automate the identification and classification of fossils, further accelerating the analysis process.

However, the successful integration of these technologies into practical biostratigraphic workflows faces several challenges. The relatively large volume of image data generated by automated microscope systems may overwhelm traditional data handling and analysis approaches, creating bottlenecks and hindering the extraction of meaningful insights. Also, automated systems may lack the flexibility and intuitiveness to replicate the nuanced decision-making processes of human biostratigraphers. The absence of tools for such data filtering, targeted searching, and interactive visualization may limit the ability of a user to navigate the data landscape and identify useful biostratigraphic markers.

It is also difficult to balance trade-offs between image quality, coverage area, and scan time. For example, high-resolution imaging is useful for accurate fossil identification, but may require prolonged scan times and result in large volumes of data. On the other hand, lower resolution imaging (or reduced coverage) may compromise the detection of rare (e.g., infrequently occurring) or sparsely distributed fossils, which are generally useful for age determination and correlation.

### SUMMARY

In an embodiment, a method includes preparing a slide with a rock sample; and capturing, with a slide scanner, a plurality of images of the slide in a non-continuous scanning pattern until a predetermined coverage percentage of the slide is captured, where each image is a block of a predetermined block dimension. The method also includes generating a prediction for each of the images, where the prediction for an image includes an identification of a fossil of a species present in the image and a confidence level associated with the identification; filtering the images based on a confidence level threshold for the confidence level associated with the identified species; and generating a filtered set of images comprising the prediction for each image.

In another embodiment, a system includes a slide scanner and an electronic device coupled to the slide scanner. The electronic device includes one or more processors, and a memory coupled to the one or more processors and storing instructions that, when executed by the one or more processors, cause the electronic device to be configured to: cause the slide scanner to capture a plurality of images of a slide prepared with a rock sample in a non-continuous scanning pattern until a predetermined coverage percentage of the slide is captured, where each image is a block of a predetermined block dimension; generate a prediction for each of the images, where the prediction for an image includes an identification of a fossil of a species present in the image and a confidence level associated with the identification; filter the images based on a confidence level threshold for the confidence level associated with the identified species; and generate a filtered set of images comprising the prediction for each image.

In yet another embodiment, a non-transitory computer-readable medium stores instructions that, when executed by one or more processors of an electronic device, cause the electronic device to be configured to: cause a slide scanner to capture a plurality of images of a slide prepared with a rock sample in a non-continuous scanning pattern until a predetermined coverage percentage of the slide is captured, where each image is a block of a predetermined block dimension; generate a prediction for each of the images, where the prediction for an image includes an identification of a fossil of a species present in the image and a confidence level associated with the identification; filter the images based on a confidence level threshold for the confidence level associated with the identified species; and generate a filtered set of images comprising the prediction for each image.

Embodiments described herein include a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A is a schematic level diagram that illustrates an example of samples to be analyzed by an analysis system constructed and operating in accordance with an embodiment of this disclosure;

FIG. 1B is a block diagram for an analysis system for analyzing samples in accordance with an embodiment of this disclosure;

FIG. 1C is a block diagram for a computing device suitable for use in an analysis system for analyzing core samples in accordance with an embodiment of this disclosure;

FIG. 2A is a schematic diagram of a scanning pattern for automated microscopic image acquisition for biostratigraphic analysis in accordance with an embodiment of this disclosure;

FIG. 2B is a schematic diagram of another scanning pattern for automated microscopic image acquisition for biostratigraphic analysis in accordance with an embodiment of this disclosure;

FIG. 3 is a schematic diagram of different objective magnifications for automated microscopic image acquisition for biostratigraphic analysis in accordance with an embodiment of this disclosure;

FIG. 4 is a schematic diagram of an example user interface (UI) for validation of machine learning predictions in biostratigraphic analysis in accordance with an embodiment of this disclosure;

FIG. 5 is a flow diagram of a method for filtering and organizing images and associated data in accordance with an embodiment of this disclosure; and

FIG. 6 is a block diagram of a computer system configured to implement one or more embodiments described herein.

### DETAILED DESCRIPTION

It should be understood at the outset that although an illustrative implementation of one or more embodiments are provided below, the disclosed systems and/or methods may be implemented using any number of techniques, whether currently known or yet to be developed. The present disclosure should in no way be limited to the illustrative implementations, drawings, and techniques illustrated below, including the exemplary designs and implementations illustrated and described herein, but may be modified within the scope of the appended claims along with their full scope of equivalents.

Thus, while several embodiments have been provided in the present disclosure, it may be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

The field of biostratigraphy, particularly when applied in the oil and gas industry, facilitates the determination of the age and depositional environment of subsurface formations. This information may help identify potential hydrocarbon reservoirs and improve drilling strategies. Biostratigraphy conventionally relies on manual analysis (e.g., by highly trained specialists) of microfossils, such as calcareous nannofossils. Such manual analysis is labor-intensive, time-consuming, and prone to subjective interpretation.

Calcareous nannofossils are microscopic, calcium carbonate platelets produced by marine algae. Their distinct morphologies and evolutionary patterns make them useful biostratigraphic markers. The identification and classification of nannofossils generally require extensive expertise and experience. Specialists must be able to recognize subtle differences in morphology, sometimes in varying preservation states and orientations.

Accurate biostratigraphic analysis is useful in understanding subsurface geology and improving exploration and production activities. The manual nature of conventional biostratigraphic analysis presents several challenges. In one particular example, a rock sample (e.g., a core sample, wellbore cuttings, and the like) is prepared into one or more slides (e.g., microscope slides) for further analysis, such as to identify and classify nannofossils present in the slide(s). A given project may seek to analyze the nannofossils from a particular region, and thus one or more samples from that region may be prepared into an even greater number of slides. Accordingly, for such a project, there may be a relatively large number of slides to be analyzed by a biostratigrapher.

Further, the limited availability of highly skilled specialists may create workflow bottlenecks and delay decision-making. Relying on a human for biostratigraphic analysis also introduces subjectivity in nannofossil identification, which may lead to inconsistencies in results (e.g., differing opinions between different human biostratigraphers) and uncertainty in stratigraphic interpretations. Such subjectivity may also impact drilling decisions and resource estimates, at least because of the additional uncertainty that is introduced to the workflow. The time required for manual analysis may also introduce additional costs to exploration and production activities, which is not desirable. Accordingly, accelerating biostratigraphic workflows may lead to financial savings, as well as improved decisions related to hydrocarbon exploration, drilling, and/or production.

Machine learning and/or computer vision techniques may be applied to at least partially automate a biostratigraphic analysis workflow. However, successful implementation of such automation may require addressing several challenges. One challenge lies in efficiently collecting and managing large amounts of image data generated by automated microscope systems. These systems may capture thousands, if not hundreds of thousands, of images per sample. Such systems may benefit from more robust data handling and analysis workflows.

Another challenge is related to the replication of conventional biostratigraphic practices within an automated framework. By virtue of their training and intuition, biostratigraphers employ a combination of targeted and random scanning approaches to identify key marker species, which are helpful for age determination and correlation, in slide(s) of a sample. Mimicking such human behavior in an automated approach may be difficult. Accordingly, in some embodiments described herein, particular approaches to data sorting, searching, and visualization are leveraged to better implement such strategies to better mimic human biostratigraphic analysis.

Existing automated microscope systems are generally unable to efficiently handle and process the large volume of generated image data, which introduces a bottleneck in the biostratigraphic analysis workflow. As a result, human analysts may be overwhelmed by the volume of data, which hinders their ability to extract meaningful insights in a timely manner. Further, automated systems may struggle to replicate the nuanced decision-making processes of human biostratigraphers. The lack of tools for data sorting, searching, and visualization may limit the ability of a user to navigate image datasets, identify key marker species, and make informed interpretations. In addition, variability in fossil preservation and abundance may pose challenges for automated analysis. For example, rare marker species, which are useful for biostratigraphic correlation, may be overlooked in the images generated by automated systems, leading to incomplete or inaccurate interpretations and potentially impacting decision-making in hydrocarbon exploration/production scenarios.

Embodiments of the present disclosure address these challenges through a particular approach to data collection, sorting, and searching in the context of automated biostratigraphic analysis. The embodiments described herein improve the image acquisition process by using particular microscope settings (e.g., objective magnification, focal density), as well as selecting a scan time, a slide coverage (e.g., percentage), and/or a scanning pattern useful to capture images of a slide. A system for collecting images of a slide may include an automated optical microscope (e.g., a slide scanner), in which raw images of a slide/sample are acquired for further analysis according to embodiments of the disclosure. In an embodiment, the objective magnification for image acquisition may be approximately 60×, the focal density for image acquisition may be a continuous focus setting, the slide coverage for image acquisition may be approximately 20-30%, and the scanning pattern is a non-continuous scanning pattern. The non-continuous scanning pattern may be random (e.g., with no or minimal user-provided parameters or guidance), semi-random (e.g., based on at least some user-provided parameters, with other aspects being random), or user-programmed. Experimental validation has demonstrated that such settings may enable an improved balance between image quality, data volume, and acquisition time, which in turn results in efficient collection of representative data without overwhelming the system or users thereof.

In some embodiments, various filtering and sorting mechanisms are employed to improve data analysis and prioritize relevant information. For example, predictions generated by the machine learning model may be pre-sorted based on their confidence levels, allowing users to focus on sufficiently reliable identifications and streamline the validation process. Further, predictions may be filtered based on the estimated age ranges of the samples, reducing misclassifications and refining the dataset for more accurate stratigraphic interpretations. Additionally, images classified as non-fossils (e.g., air bubbles or debris) may be automatically removed, further refining the dataset and minimizing distractions for the user.

In some embodiments, user experience may be improved by providing tools for data navigation, validation, and interpretation. For example, a “bulk validate” feature may allow users to efficiently validate species predictions in bulk, accelerating the review process and enabling faster stratigraphic interpretations. Further, various sorting mechanisms (e.g., by confidence level or sample depth) and search functionalities (e.g., by species or multiple predictions) may be incorporated to help users quickly locate and access relevant information within the relatively large image dataset. Additionally, metadata associated with the images (e.g., abundance counts, confidence levels, size distributions) may be presented in a user-friendly graphical interface. Such a presentation may empower users to understand the data more deeply, identify areas requiring further attention, and make informed decisions regarding model training and validation.

In some cases, the design and features of the disclosed embodiments more closely represent aspects of traditional biostratigraphic workflows, which may ease user transition from manual biostratigraphic to the automated biostratigraphic analysis of the disclosed embodiments. In these embodiments, such designs and features may include the ability to perform targeted searches for rare marker species, which are useful for age determination and correlation, and to visualize data in a manner conducive to stratigraphic interpretation.

By addressing various limitations, embodiments of the present disclosure provide a solution for efficient data collection, sorting, searching, and interpretation in automated biostratigraphic analysis. These approaches may enhance the practical applicability of machine learning in the biostratigraphy field, facilitating faster, more accurate, and more consistent results, ultimately leading to improved decision-making and resource optimization in hydrocarbon exploration and production. These and other embodiments are described more fully below, with reference made to the accompanying figures.

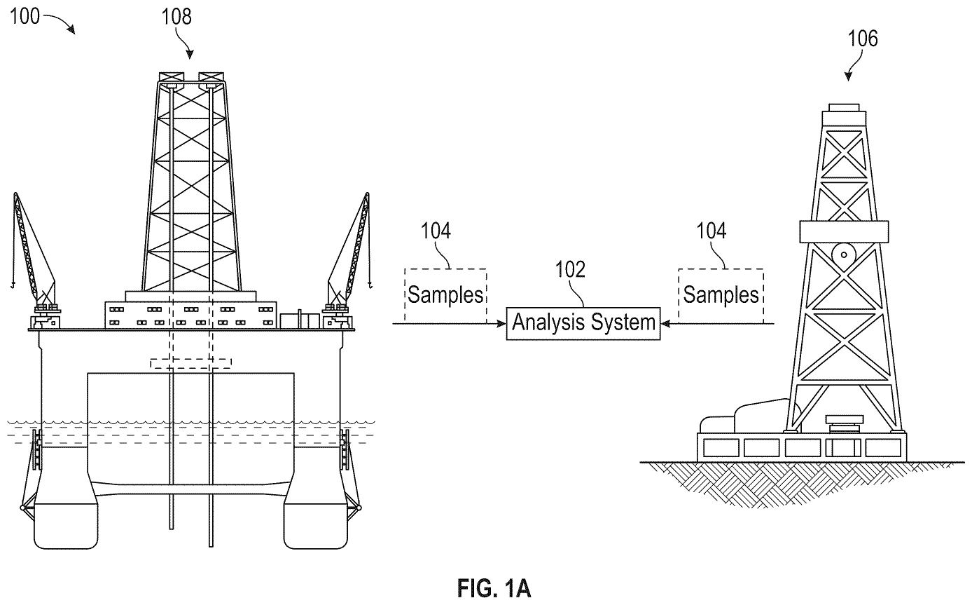

FIG. 1A illustrates, at a high level, the acquiring of samples 104 and the analysis of the samples according to principles disclosed herein. Embodiments of the present disclosure may be especially beneficial in analyzing samples from sub-surface formations that are important in the production of oil and gas. As such, FIG. 1A illustrates environments 100 from which samples 104 to be analyzed by analysis system 102 may be obtained, according to various implementations. In these illustrated examples, samples 104 may be obtained from terrestrial drilling system 106 or from marine (ocean, sea, lake, etc.) drilling system 108, either of which is utilized to extract resources such as hydrocarbons (oil, natural gas, etc.), water, and the like. The samples 104 may be cutting samples, outcrop samples, and/or core samples. Optimization or improvement of oil and gas production operations is largely influenced by the structure and material properties of the rock formations into which terrestrial drilling system 106 or marine drilling system 108 is drilling or has drilled in the past.

The manner in which samples 104 are obtained, and the physical form of those samples, may vary widely. Examples of samples 104 useful in connection with embodiments disclosed herein include whole core samples, side wall core samples, outcrop samples, drill cuttings, rock samples. As illustrated in FIG. 1A, the environment 100 includes analysis system 102 that is configured to analyze images 128 (FIG. 1B) of samples 104 in order to determine the material properties of the corresponding sub-surface rock.

FIG. 1B illustrates, in a generic fashion, the constituent components of the analysis system 102 that analyzes images 128. In a general sense, analysis system 102 includes imaging device 122 for obtaining two-dimensional (2D) or three-dimensional (3D) images, as well as other representations, of samples 104, such images and representations including details of the internal structure of the samples 104. In particular embodiments, the samples 104 include prepared slide(s) of the obtained rock sample, and the imaging device 122 is configured to capture images of such prepared slide(s). The particular type, construction, or other attributes of imaging device 122 may correspond to that of any type of device capable of producing an image representative of the sample 104. The imaging device 122 generates one or more images 128 of sample 104, and forwards those images 128 to a computing device 120. The images 128 produced by imaging device 122 may be generated from a plurality of two-dimensional (2D) sections of sample 104.

FIG. 1C generically illustrates the architecture of computing device 120 in analysis system 102 according to various embodiments. In this example architecture, computing device 120 includes one or more processors 152, which may be of varying core configurations and clock frequencies as available in the industry. The memory resources of computing device 120 for storing data and/or program instructions for execution by the one or more processors 152 include one or more memory devices 154 serving as a main memory during the operation of computing device 120, and one or more storage devices 160, for example realized as one or more of non-volatile solid-state memory, magnetic or optical disk drives, or random-access memory. One or more peripheral interfaces 156 are provided for coupling to corresponding peripheral devices such as displays, keyboards, mice, touchpads, touchscreens, printers, and the like. Network interfaces 158, which may be in the form of Ethernet adapters, wireless transceivers, serial network components, etc. are provided to facilitate communication between computing device 120 via one or more networks such as Ethernet, wireless Ethernet, Global System for Mobile Communications (GSM), Enhanced Data rates for GSM Evolution (EDGE), Universal Mobile Telecommunications System (UMTS), Worldwide Interoperability for Microwave Access (WiMAX), Long Term Evolution (LTE), and the like. In this example architecture, processors 152 are shown as coupled to components 154, 156, 158, and 160 by way of a single bus; of course, a different interconnection architecture such as multiple, dedicated, buses and the like may be incorporated within computing device 120.

While illustrated as a single computing device, computing device 120 may include several computing devices cooperating together to provide the functionality of a computing device. Likewise, while illustrated as a physical device, computing device 120 may also represent abstract computing devices such as virtual machines and “cloud” computing devices.

As shown in the example implementation of FIG. 1C, the computing device 120 includes software programs 162 including one or more operating systems, one or more application programs, and the like. According to embodiments, software programs 162 include program instructions corresponding to testing tool 130 (FIG. 1B), implemented as a standalone application program, as a program module that is part of another application or program, as the appropriate plug-ins or other software components for accessing testing tool software on a remote computer networked with computing device 120 via network interfaces 158, or in other forms and combinations of the same.

The program memory storing the executable instructions of software programs 162 corresponding to the functions of testing tool 130 may physically reside within computing device 120 or at other computing resources accessible to computing device 120, i.e. within the local memory resources of memory devices 154 and storage devices 160, or within a server or other network-accessible memory resources, or distributed among multiple locations. In any case, this program memory constitutes a non-transitory computer-readable medium that stores executable computer program instructions, according to which the operations described in this specification are carried out by computing device 120, or by a server or other computer coupled to computing device 120 via network interfaces 158 (e.g., in the form of an interactive application upon input data communicated from computing device 120, for display or output by peripherals coupled to computing device 120). The computer-executable software instructions corresponding to software programs 162 associated with testing tool 130 may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed by computing device 120 in the conventional manner for software installation. It is contemplated that those skilled in the art will be readily able to implement the storage and retrieval of the applicable data, program instructions, and other information useful in connection with this embodiment, in a suitable manner for each particular application, without undue experimentation.

The particular computer instructions constituting software programs 162 associated with testing tool 130 may be in the form of one or more executable programs, or in the form of source code or higher-level code from which one or more executable programs are derived, assembled, interpreted or compiled. Any of a number of computer languages or protocols may be used, depending on the manner in which the desired operations are to be carried out. For example, these computer instructions for creating the model according to embodiments may be written in a conventional high-level language such as PYTHON, JAVA, FORTRAN, or C++, either as a conventional linear computer program or arranged for execution in an object-oriented manner. These instructions may also be embedded within a higher-level application. In any case, it is contemplated that those skilled in the art having reference to this description will be readily able to realize, without undue experimentation, embodiments in a suitable manner for the desired installations.

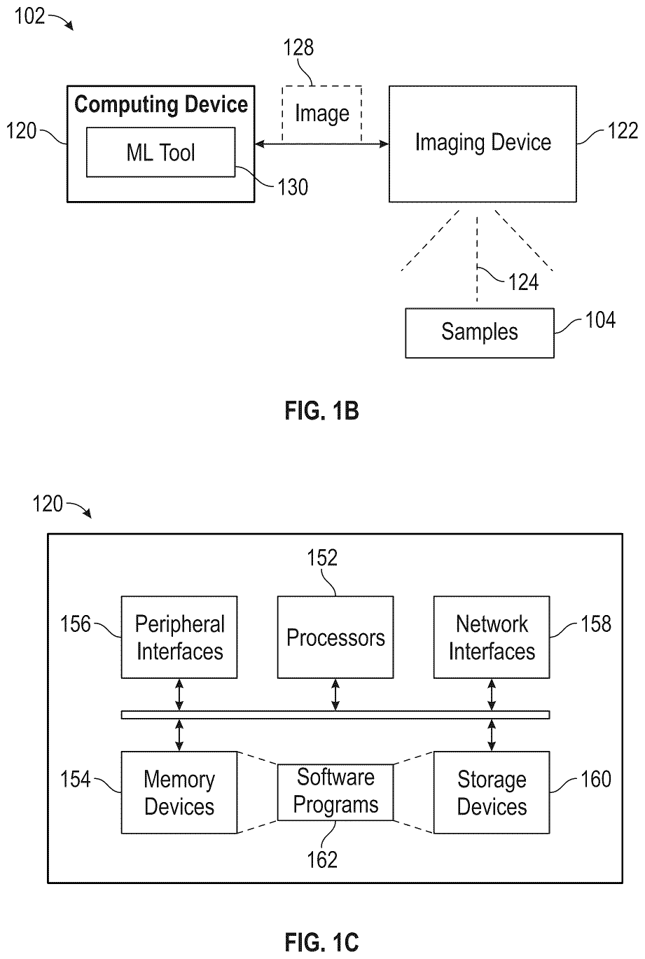

FIG. 2A is a schematic illustration of a continuous scanning pattern 200 that is applied to a sample 104 (in this example, a slide 104) for automated microscopic image acquisition for biostratigraphic analysis. The scanning pattern in FIG. 2A is a continuous scanning pattern 200. The continuous scanning pattern 200 may be applied to a prepared slide 104 at various sample depths (e.g., 10,000-10,030 feet) and may dictate the manner in which the imaging device 122 (e.g., a slide scanner 122, such as the OLYMPUS VS200) captures images across the prepared slide 104. Choosing the continuous scanning pattern 200 may influence the efficiency and effectiveness of data collection, particularly in identifying rare or sparsely distributed fossil specimens.

In these examples, the prepared slide 104 is a well slide. A well slide is a microscope slide prepared with material extracted from a wellbore during drilling or coring operations. This material, sometimes referred to as cuttings or core samples, contains rock fragments and microfossils that may provide useful information about the subsurface geology and potential hydrocarbon reservoirs. The well slide is generally prepared by dispersing the cuttings or core material in a mounting medium on a glass slide, allowing for microscopic examination of the microfossils present in the sample. These microfossils, including calcareous nannofossils, may be used to determine the age and depositional environment of the rock formations encountered in the wellbore, aiding in the assessment of hydrocarbon potential.

In the continuous scanning pattern 200, the slide scanner 122 may traverse the prepared slide 104 in a continuous, linear fashion, capturing images along a predetermined scanning path 210. In other continuous scanning patterns 200, the slide scanner 122 may traverse the prepared slide 104 in a less linear or “organized” path, but still captures images in a continuous path. These continuous scanning pattern approaches provide relatively comprehensive coverage of the prepared slide 104, increasing the possibility that a large portion of the prepared slide 104 is imaged. Reference herein to a continuous scanning pattern 200 is not limited to a particular path taken during image acquisition. Regardless of the path taken, however, the continuous scanning pattern 200 may be less efficient than other scanning patterns (e.g., a non-continuous scanning pattern 250, discussed further below) in detecting rare or sparsely distributed fossils because the predetermined scanning path 210 is fixed and may not prioritize areas with higher fossil concentrations. In particular, the continuous scanning pattern 200 may take a relatively long amount of time compared to another scanning pattern, such as the non-continuous scanning pattern 250 discussed below.

FIG. 2B is a schematic illustration of a non-continuous scanning pattern 250 that is applied to a sample 104 (in this example, a slide 104) for automated microscopic image acquisition for biostratigraphic analysis. The non-continuous scanning pattern 250 may be applied to a prepared slide 104 at various sample depths and may dictate the manner in which a slide scanner captures images across the prepared slide 104. Choosing the non-continuous scanning pattern 250 may influence the efficiency and effectiveness of data collection, particularly in identifying rare or sparsely distributed fossil specimens.

In contrast to the continuous scanning pattern 200, in the non-continuous scanning pattern 250, the slide scanner 122 captures images at random or user-programmed intervals throughout the prepared slide 104, focusing on multiple discrete areas or blocks 260a-260g. This approach may increase the probability of encountering rare or sparsely distributed fossils on the prepared slide 104 because the scanning pattern 250 is not constrained to a specific path (e.g., the predetermined scanning path 210). By sampling different regions (e.g., the blocks 260) of the prepared slide 104, the non-continuous scanning pattern 250 may capture a more representative and diverse set of fossil specimens.

The blocks may be of different shapes and have varying dimensions. For example, blocks may be square (e.g., 0.5 cm×0.5 cm, 1 cm×1 cm, 2 cm×2 cm), rectangular (e.g., 0.5 cm×1 cm, 1 cm×2 cm), or other shapes (e.g., circular). Smaller blocks (e.g., 0.5 cm×0.5 cm) may be suitable for samples with high fossil density or when greater detail is required for specific taxonomic groups. Larger blocks (e.g., 2 cm×2cm) may be used for samples with low fossil abundance or when a broader overview of the fossil assemblage is desired. Blocks with dimensions between smaller or larger blocks (e.g., 1 cm×1 cm) may offer a balance between capturing sufficient context for fossil identification and maintaining reasonable scan times. Relatedly, rectangular blocks (e.g., 0.5 cm×1 cm, 1 cm×2 cm) may be useful for capturing elongated or oriented fossils, allowing for morphological features associated with such fossils to be better represented in the image. Similarly, circular blocks may be used to capture fossils with radial symmetry or to reduce edge effects in image analysis. Depending on the specific characteristics of the fossil assemblage or research objectives, custom-shaped blocks may be defined to improve data collection.

The choice of block dimensions may depend on several factors, including fossil size and abundance, desired level of content, image resolution, and computational resources. For example, smaller block dimensions may be considered for samples with small or densely packed fossils, while larger blocks may be used for samples with larger or sparsely distributed fossils. Relatedly, larger block dimensions may provide more contextual information about the fossil assemblage and its spatial distribution, but they may also increase data volume and scan time. Additionally, higher-resolution imaging may necessitate smaller block dimensions to ensure adequate detail for fossil identification. Further, processing and analysis of large numbers of images may be computationally intensive. Thus, the choice of block dimensions may be influenced by the available computational resources.

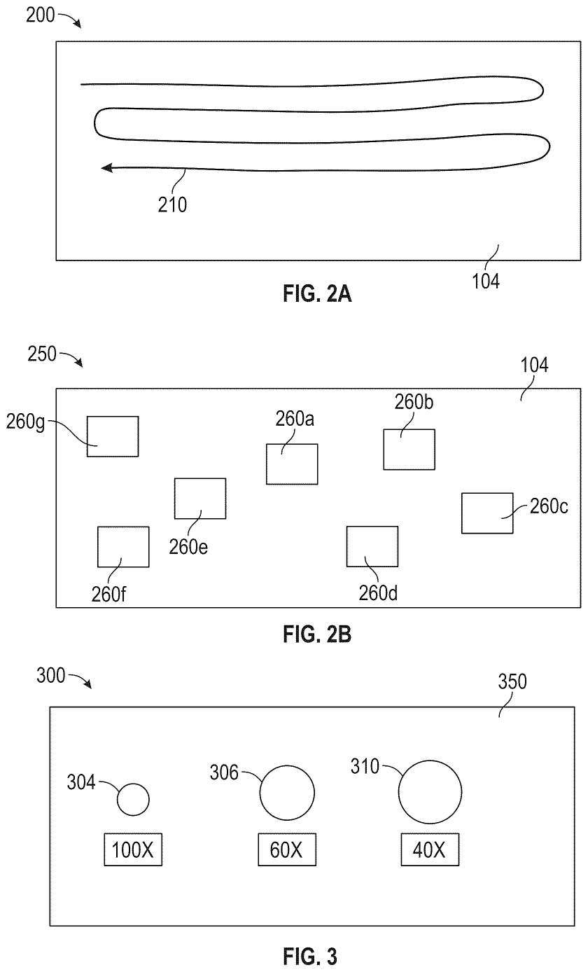

FIG. 3 is a schematic diagram of objective magnifications that may be employed in automated microscopic image acquisition for biostratigraphic analysis. A relative field of view 304, a relative field of view 306, and a relative field of view 310 are shown on a slide 350. As depicted, the relative field of view 304 is observed under a magnification level greater than that of the relative field of view 306, while the relative field of view 306 is observed under a magnification level greater than that of the relative field of view 310. For example, the relative field of view 304 may be observed under a 100× magnification, the relative field of view 306 may be observed under a 60× magnification, and the relative field of view 310 may be observed under a 40× magnification.

In microscopy, as magnification increases, the field of view decreases. This inverse relationship implies that a higher magnification objective provides a more detailed view of a smaller area, while a lower magnification objective captures a wider area but with less detail. In the context of automated biostratigraphic analysis, such a trade-off between magnification and field of view may be worthwhile to consider. Higher magnifications generally allow for better visualization of intricate nannofossil morphologies, aiding in more accurate identification and classification. However, a higher magnification may also necessitate capturing a larger number of images to cover the same sample area, potentially increasing scan time and data volume. For example, while a 100× objective may offer a high resolution, its limited field of view may necessitate longer scan times and generate a larger volume of image data. Conversely, a 40× objective may not provide sufficient detail for reliable nannofossil identification.

A magnification objective may be chosen to balance the benefits of enhanced visualization associated with higher magnification and reduced scan times and data volume associated with lower magnifications. For example, a 60× objective may represent a choice that enables the acquisition of high-quality images with sufficient detail for accurate analysis while maintaining reasonable scan times and data volumes. Thus, the relative field of view 306 may be one that balances such benefits as opposed to the relative field of view 304 or the relative field of view 310.

Similar to scanning patterns or objective magnifications, other settings may be employed in automated microscopic image acquisition systems for biostratigraphic analysis. For example, various focal densities, scan times, and percentages of slide coverage settings may be employed.

Calcareous nannofossils are 3D structures. Their complex morphologies (e.g., relatively delicate coccoliths and intricate surface ornamentation) may be challenging to fully capture and interpret in a single 2D image. Conventional microscopic examination generally allows for manual adjustment of the focal plane, enabling an observer to visualize different aspects of the structure of the nannofossil in sharp focus. However, automated imaging systems, while offering advantages in terms of speed and efficiency, may have limitations in dynamically adjusting focus during image capture. These limitations may result in images where certain features of the nannofossil are in focus while others are blurred, potentially hindering accurate identification and classification by the machine learning model.

In automated microscopy, focus depth settings play a role in determining the clarity and depth of field in captured images. The focus depth, or the number of focal planes imaged and merged, may influence the ability to visualize 3D structures within a sample. Acquiring and merging images from different focal planes may be referred to as z-stacking. Employing z-stacking with an increased focus depth may increase scan times and result in larger data volumes because of the larger number of focal planes being imaged, which poses challenges for efficient image acquisition.

The embodiments described herein address such challenges by considering various settings related to a focusing routine or approach (e.g., z-stacking) to identify one that balances image quality and data collection efficiency. In addition to offering a range of different focus depth options, a slide scanner may also offer other focus settings such as pre-focus and continuous focus. A pre-focus setting determines a focal plane for each of various locations before imaging begins, which results in fast scan times, but that may have a limited depth of field for 3D structures. By contrast, a continuous focus setting determines focus measurements or settings during scanning, and thus may more accurately capture 3D structures at varying depths across the sample, providing a more comprehensive 3D representation, but sometimes with longer resultant scan times.

Testing and evaluation may aid in determining a focusing routine or approach that works effectively with a specific objective magnification. For example, through testing and evaluation, it may be determined that a continuous focus setting, despite its longer scan times, yields the highest accuracy rates in fossil detection and classification using machine learning models, which may suggest that a higher number of in-focus (and/or better-focused) images enabled by the continuous focus mode is more useful for accurately recognizing and distinguishing between different nannofossil species.

However, in other examples it may be useful to balance image quality and efficiency, particularly when analyzing large numbers of samples, and thus the use of the pre-focus setting may be utilized. These settings may offer a compromise between scan time and image quality, enabling faster data collection while still providing sufficient detail for reliable fossil identification in many cases. Thus, focusing protocol setting selection may depend on various factors, including the specific characteristics of the nannofossil assemblage, the desired level of accuracy in biostratigraphic analysis, and the time constraints of a project.

Additionally, scan time and percentage of slide coverage settings may be considered. In automated microscopy for biostratigraphic analysis, the scan time and percentage of slide coverage play a role in determining the quantity and representativeness of the acquired image data. Longer scan times and higher coverage percentages generally yield more images, increasing the likelihood of capturing rare or sparsely distributed fossils. However, such settings also lead to increased data volume and processing time, potentially impacting the efficiency of the workflow.

Such trade-offs may be addressed by evaluating various scan time and slide coverage settings to identify ones that balance data volume and efficiency. A slide scanner may allow for flexible adjustments of these parameters. Indeed, in at least some embodiments, one or more parameter(s) of imaging device 122 (e.g., a slide scanner) may be adjusted in response to feedback (e.g., during training of a machine learning model, analysis by human biostratigrapher or data classifier, or a combination thereof) to achieve the various objectives of the present disclosure.

The scan time refers to the duration spent capturing images from a single slide. Accordingly, scan time is a function of both the length of time to capture a single image, as well as the number of images captured of a given slide. Longer scan times allow for more comprehensive coverage but may also lead to delays in data acquisition, particularly when analyzing large numbers of samples.

The percentage of slide coverage parameter determines the proportion of the slide area that is imaged. The percentage of slide coverage may be indicated as a range (e.g., 20-25%) in some embodiments. Higher coverage percentages generally increase the likelihood of capturing rare fossils but also result in a larger volume of image data.

A predetermined coverage percentage may be set when utilizing a scanning pattern. Lower coverage percentage ranges (e.g., 5-10%, 15-20%) may be suitable for preliminary screening or rapid assessment of samples, where the goal is to quickly identify the presence or absence of marker species. Such lower percentage ranges may also be employed when dealing with samples with high fossil abundance, where a smaller coverage area may still yield sufficient data for accurate analysis. Medium coverage percentage ranges (e.g., 20-25%, 30-40%) may offer a balance between data volume and capturing a representative sample of the fossil assemblage. Such medium percentage ranges may also be considered for samples with moderate fossil abundance or when a slightly more comprehensive analysis is desired without significantly increasing scan time. High coverage percentage ranges (e.g., 40-60%, 60-80%) may be suitable for samples with low fossil abundance or sparsely distributed marker species, improving the chances that a sufficient number of these useful taxa are captured for accurate identification and stratigraphic correlation. Such high coverage percentage ranges may also be employed when detailed and comprehensive analysis is required, particularly for research purposes or when dealing with complex geological formations. While other percentage ranges (e.g., greater than 80%) may be possible, scanning such large portions of the slide may be overly time-consuming and may not yield significant additional benefits in terms of accuracy or representativeness to be justified.

The choice of a coverage percentage may depend on several factors, including fossil abundance and distribution, desired level of accuracy, time constraints, and computational resources. For example, samples with low fossil abundance or sparsely distributed marker species may necessitate higher coverage percentages to ensure adequate representation in the training library. Additionally, higher accuracy in biostratigraphic analysis may demand more comprehensive data collection, potentially necessitating higher coverage percentages. Also, project timelines and resource availability may influence the choice of coverage percentage, with lower percentages being favored when rapid results are desired. Further, the processing and analysis of large numbers of images may be computationally intensive. Thus, the choice of coverage percentage may be influenced by the available computational resources.

Testing and evaluation may aid in determining scan time and percentage of slide coverage settings that work effectively with a specific objective magnification. For example, setting choices may include a minimum-length scan (e.g., covering 10% of the slide area and 1 hour per light field (e.g., each of cross-polarized light and plain light)), a medium-length scan (e.g., covering 25% of the slide area and 2.5 hours per light field), and a full-length scan (e.g., covering 80% of the slide area and 8 hours per light field). Through testing and evaluation, it may be determined that the medium-length scan covering 25% of the slide area provides an adequate balance between data volume and efficiency for many applications. Such a setting may require approximately 2.5 hours per light field to complete, or 5 hours total in the case where cross-polarized and plain light fields are utilized.

In other embodiments, other scan time and coverage settings may be used to accommodate varying needs and priorities. For example, a shorter scan time with lower coverage may be suitable for preliminary screening or rapid assessment of samples. Conversely, a longer scan time with higher coverage could be employed when a more comprehensive analysis is required, particularly when targeting rare marker species useful for biostratigraphic correlation.

The choice of scan time and coverage settings may depend on several factors, such as fossil abundance and distribution, desired level of accuracy, and time constraints. For example, samples with low fossil abundance or sparsely distributed marker species may necessitate longer scan times and higher coverage to ensure adequate representation. Additionally, higher accuracy in biostratigraphic analysis may require more comprehensive data collection, potentially necessitating longer scan times and higher coverage. Further, project timelines and resource availability may influence the choice of scan settings, with shorter scan times being favored when rapid results are needed.

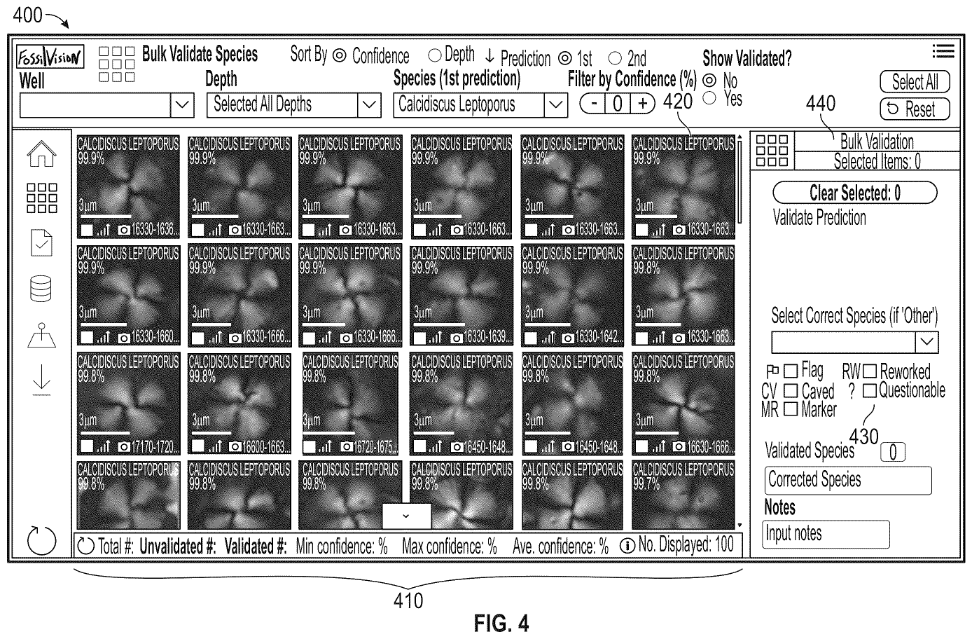

FIG. 4 is a schematic diagram of an example user interface (UI) 400 for validation of machine learning predictions in biostratigraphic analysis in accordance with an embodiment of this disclosure. The UI 400 may be implemented to address the challenges of reviewing and verifying large volumes of image data generated by automated microscope systems described herein.

The central portion of the UI 400 displays a grid of images 410, with each image representing a microscopic field of view captured by imaging device 122 (e.g., a slide scanner). The images in the grid 410 may depict the target fossils for identification and classification (e.g., calcareous nannofossils) in a machine-learning workflow. Each image may be accompanied by a label 420 indicating the prediction of the machine learning model for the dominant nannofossil species present in that image. The label 420 may also include a confidence level, reflecting the certainty of the model in its prediction.

The UI 400 may provide interactive controls 430, allowing a user to validate or correct the predictions of the model. Correcting predictions may include confirming the predicted species, selecting an alternative species from a list, or marking the image as containing no identifiable fossils using the interactive controls 430. A “bulk validate” feature 440 may allow a user to validate multiple predictions simultaneously, possibly aiding in streamlining the review process. The interactive controls 430 may also include sorting and filtering mechanisms to group images based on confidence levels, sample depths, or other relevant criteria, which further facilitates the ability to efficiently perform bulk validation on images.

For example, a user may set a confidence threshold of 90%. Utilizing the “bulk validate” feature 440, the UI 400 may validate all predictions with confidence levels above the confidence threshold. This may allow the user to focus on reviewing and validating the remaining predictions with lower confidence levels, improving accuracy while minimizing manual effort.

In another example, a user may select a depth interval of interest within a well using the “bulk validate” feature 440. The UI 400 may display all images and predictions associated with that depth interval. The user may then bulk validate predictions within that interval, improving the review process for specific stratigraphic zones.

In yet another example, a user may select a specific nannofossil species or group of species using the “bulk validate” feature 440. The UI 400 may display all images where the model has predicted the presence of those species. The user may then bulk validate these predictions, focusing on confirming or correcting identifications for taxa of particular interest.

The UI 400 may also allow the combination of multiple filtering and sorting criteria using the “bulk validate” feature 440. For example, a user may filter by a specific depth interval and a minimum confidence threshold, then bulk validate the resulting subset of predictions. Additionally, the bulk validation process may include interactive elements, such as allowing the user to scroll through images, zoom in on specific regions, or compare predictions with reference images. Further, the validated predictions may be used to update the machine learning model, improving its accuracy and performance over time. Using the validated predictions to update the machine learning model may create a continuous feedback loop that enhances the adaptability and effectiveness of the system.

These are just a few exemplary embodiments of the “bulk validate” feature 440 and its associated functionality within the UI 400. The specific implementation may vary depending on the specific requirements and preferences of the user. However, in general, the bulk validation functionality enabled by the illustrative UI 400 improves the validation process, and enables efficient and accurate review of large volumes of image data generated by automated microscope systems described herein. The bulk validation functionality may also enable more efficient training and/or retraining of the models described herein.

Additionally, the UI 400 may incorporate various sorting and filtering options to aid in data navigation and prioritization. Users may sort images based on confidence levels, sample depths, or other attributes, allowing them to focus on specific regions or specimens of interest. The UI 400 may also include visual displays of metadata associated with the images, such as abundance counts, confidence levels, and size distributions. Such information may provide useful insights into the performance of the model and guide the validation efforts of the user.

These and other features of UI 400 may allow for the system to have a user-centric design and focus on efficient data validation. By providing an intuitive and interactive interface with bulk validation capabilities and flexible sorting and filtering options, users may be more empowered to navigate and interpret large volumes of image data effectively. These capabilities may, in turn, enhance the practical applicability of machine learning in biostratigraphic analysis, facilitating faster, more accurate, and more consistent results, ultimately leading to improved decision-making in hydrocarbon exploration and production.

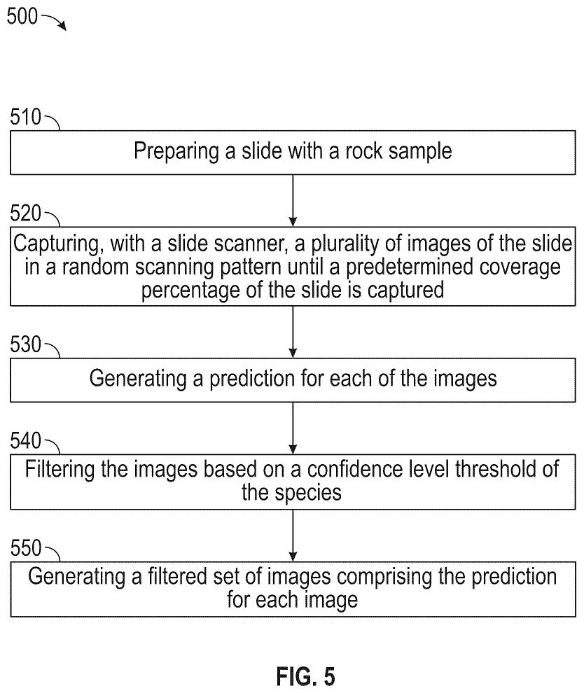

FIG. 5 is a flow diagram for a method 500 for filtering and organizing images and associated data in accordance with an embodiment of this disclosure. In the context of automated biostratigraphic analysis, filtering and organizing image data and associated predictions is the process of refining and structuring information generated by machine learning models when analyzing microscopic fossil images. This process may also include sorting images, data, and/or datasets for a user to interact with after machine learning models have been trained. In these ways, the method 500 may be useful in extracting meaningful insights from the data and facilitating efficient interpretation by users.

At step 510, the method 500 includes preparing a slide with a rock sample. For example, a rock sample (e.g., a core sample, wellbore cuttings, and the like) is prepared into one or more slides (e.g., microscope slides) for further analysis, such as to identify and classify nannofossils present in the slide(s).

The method 500 continues at step 520 with capturing a plurality of images of the slide with a slide scanner. The images are captured in a non-continuous (e.g., random, semi-random, or user-programmed) scanning pattern until a predetermined coverage percentage of the slide is captured. Microscope slide scanners, while capable of capturing high-resolution images, face a trade-off between image quality, coverage area, and scan time. Conventionally, continuous scanning patterns have been employed, systematically capturing images across the entire slide. However, as discussed above, this continuous scanning pattern approach may be time-consuming, particularly when dealing with large samples or high-resolution settings. Also, it may be useful to distribute the total captured image area around the slide. For example, if the total captured image area is 250 mm², and only one 250 mm² image is captured, rare or sparsely distributed fossils, which are useful for biostratigraphic interpretation, may be missed. Conversely, if five 50 mm² images are captured, this increases the likelihood of imaging such rare or sparsely distributed fossils.

In addressing such challenges, the method 500 uses a non-continuous scanning pattern for image acquisition (as described above with respect to FIG. 2B). In this non-continuous scanning pattern approach, the slide scanner captures images in discrete blocks of predetermined dimension at certain intervals throughout the sample. This strategy prioritizes efficiency by focusing on a representative subset of the slide area, while also increasing the likelihood of encountering rare or sparsely distributed fossils.

As discussed above (with respect to FIG. 2B), the blocks may be of different shapes (e.g., square, rectangular) and have varying dimensions (e.g., 1 cm×1 cm, 1 cm×2cm), and the choice of block dimension may depend on several factors, including fossil size and abundance, desired level of content, image resolution, and computational resources. The selection of block dimensions may be determined through experimentation and validation. Based on these considerations, the predetermined block dimension may ensure that each captured image contains sufficient context for accurate fossil identification and classification. The intervals at which these blocks are captured introduce an element of stochasticity, enhancing the chances of detecting sparsely distributed specimens.

The scanning process may continue until a predetermined coverage percentage of the slide is imaged. As discussed above, the choice of a coverage percentage may depend on several factors, including fossil abundance and distribution, desired level of accuracy, time constraints, and computational resources. The predetermined coverage percentage may be determined through experimentation and validation. This percentage may be indicated as a range (e.g., 15-20%) in embodiments. A percentage reflecting a medium coverage (e.g., 20-25%) may represent a balance between data volume and capturing a statistically useful representation of the fossil assemblage. For example, a 20-25% range has been shown to be effective in replicating traditional biostratigraphic workflows and achieving accurate results. The non-continuous nature of the scanning pattern may ensure that this coverage is distributed across the entire slide, improving the chances of encountering diverse fossil specimens.

In embodiments, the slide scanner may have additional settings applied before scanning the image of the sample. For example, as discussed above with respect to the FIG. 3 discussion, the slide scanner may be set with a predetermined objective magnification (e.g., 60×), a predetermined focus routine or protocol (e.g., continuous focus), and/or a predetermined scan time (e.g., 2.5 hours per light field). Similar to other predetermined settings (e.g., the predetermined block dimension, the predetermined coverage percentage) discussed above, the predetermined objective magnification, the predetermined focal density, and the predetermined scan time may be determined through experimentation and validation.

At step 530, the method 500 includes generating a prediction for each of the images. The prediction includes an identification of a fossil of a species and a confidence level associated with the identification. Image data may be transformed into meaningful predictions about the fossil species present. These predictions, however, are not mere labels because they are accompanied by a confidence level, a quantitative measure of the certainty of the model in its identification.

The generation of predictions may include feature extraction, pattern recognition, confidence calculation, and output generation. In feature extraction, a machine learning model extracts relevant features from the image, such as shape, size, texture, and color, which are used to distinguish between different nannofossil species. In pattern recognition, the model applies its learned patterns and associations to identify likely species present in the image.

For confidence calculation, the model calculates a confidence level (or score), reflecting the degree of certainty in its prediction. This confidence level may be based on various factors, such as the strength of the match between the image features and the learned patterns, the presence of ambiguous or conflicting features, and the overall performance of the model on similar images during training. The model outputs both the predicted species identification and the associated confidence level.

In embodiments, the confidence level associated with machine learning predictions for each image may be a numerical confidence level or another type of indicator of confidence (e.g., qualitative confidence levels, visual representations, adaptive confidence thresholds, ensemble-based confidence). For example, a confidence level may be a numerical value (e.g., between 0 and 1) or a percentage (e.g., between 0% and 100%), representing the probability that the prediction of the model is correct. Higher values indicate greater confidence, while lower values suggest more uncertainty. For example, a confidence level of 0.95 (or 95%) suggests a high degree of certainty in the prediction, while a confidence level of 0.5 (or 50%) indicates a less reliable identification. Relatedly, in embodiments, confidence levels may be expressed using qualitative terms, such as “high,” “medium,” or “low.” Such qualitative terms may be mapped to specific numerical ranges or thresholds, providing a more intuitive interpretation for users. For example, “high” confidence may correspond to levels (or scores) above 0.9, “medium” to levels between 0.7 and 0.9, and “low” to levels below 0.7.

In these ways, the confidence level may serve as an indicator of the reliability of each prediction. The confidence level may let users prioritize their attention and focus on sufficiently confident identifications, while also flagging potential areas of uncertainty for further review or validation. This nuanced approach to prediction generation enhances the efficiency and accuracy of the biostratigraphic workflow, enabling users to make informed decisions based on the output of the model.

At step 540, the method 500 includes filtering the images based on a confidence level threshold of the species. Machine learning models, while useful tools for automated analysis, are not infallible. Such models can produce predictions with varying degrees of certainty, and it may be useful to distinguish between high-confidence identifications and those with greater uncertainty. In the context of biostratigraphic analysis, misclassifications may lead to erroneous interpretations and potentially impact decision-making in hydrocarbon exploration. Conventionally, human experts have relied on their experience and judgment to assess the reliability of their own identifications. However, in an automated system, a quantitative measure of confidence may be useful to guide users in interpreting and validating the output of the model.

To address such challenges, a confidence level threshold may be set as a filtering mechanism. Each prediction generated by the machine learning model is accompanied by a confidence level, reflecting the degree of certainty of the model in its identification. By setting a threshold, predictions that fall below a specified level of confidence may be automatically filtered out, increasing the possibility that sufficiently reliable identifications are retained for further analysis.

In an embodiment, a generic confidence level threshold, such as “greater than 50%,” may be applied across all species, providing a baseline level of filtering to remove some uncertain predictions. Relatedly, species-specific confidence thresholds may also be accommodated. In one example of species-specific confidence thresholds, a lower threshold may be set for species that are relatively more difficult to identify and/or rare, while a relatively higher threshold may be set for species that are relatively easier to identify and/or less rare. For example, Cyclicargolithus bukyri is a relatively rare, more difficult to identify species, and thus may have its threshold set at >70%, while Coccolithus pelagicus is a relatively common, easier to identify species, and thus may have its threshold set at >90%. In some embodiments, the confidence threshold may be dynamically adjusted based on the specific context of the analysis or the preferences of the user. For example, the threshold may be lowered when analyzing samples with low fossil abundance or when searching for rare marker species, allowing for the inclusion of more predictions, even those with lower confidence levels.

Filtering predictions based on confidence level thresholds may offer several advantages, including improved accuracy and reliability, efficient workflow, and better adaptability. By focusing on high-confidence predictions, the risks of misclassifications may be reduced, and the reliability of the biostratigraphic analysis may be enhanced. Additionally, the automated filtering process may reduce the burden on users, allowing them to focus their validation efforts on sufficiently uncertain identifications. Further, the flexibility to set generic or species-specific thresholds, or even implement adaptive thresholds, may enable the system to cater to diverse analytical needs and optimize performance in different scenarios.

In these ways, filtering the prediction based on a confidence level threshold of the species may aid in delivering accurate and reliable results in automated biostratigraphic analysis. By incorporating confidence-based filtering, users may be empowered to make informed decisions based on the output of the model, contributing to more efficient and effective hydrocarbon exploration and production.

At step 550, the method 500 includes generating a filtered set of images comprising the prediction for each image, based on the confidence level threshold. In biostratigraphic analysis, the volume of image data and associated predictions generated by machine learning models may be overwhelming. To facilitate efficient interpretation and decision-making, it may be useful to distill such a dataset into a more manageable and focused collection of similar-confidence predictions. The process of filtering predictions based on a confidence level threshold, as described with respect to step 530, is one step in achieving this goal. However, it may also be useful to aggregate these filtered predictions from multiple images into a cohesive and organized dataset that may be readily accessed and analyzed by users.

The step 550 signifies the creation of a consolidated dataset that includes not only the filtered prediction from the current image but also similar-confidence predictions from other images within the sample or dataset. The aggregation of filtered predictions may offer several advantages. For example, by combining predictions from multiple images, the filtered set may provide a more holistic view of the fossil assemblage present in the sample, enabling users to identify patterns, trends, and potential anomalies. Additionally, the aggregated data may allow for statistical analysis of fossil abundance, diversity, and distribution, providing potentially useful insights for biostratigraphic interpretation and correlation. Further, the filtered set of predictions, organized and presented in a user-friendly manner, may facilitate efficient navigation and exploration of the data, enabling users to locate and access relevant information relatively quickly.

In an embodiment, a predetermined confidence threshold is applied to all predictions generated by the machine learning model for each image in the dataset. Predictions with confidence levels below the threshold are discarded. Remaining predictions with confidence levels above the threshold are aggregated into a filtered set, which may be organized or sorted based on various criteria, such as species, genus, sample depth, or other relevant attributes.

In an embodiment, the confidence threshold used for filtering may be dynamically adjusted based on the specific context of the analysis or the preferences of the user. For example, if a user is interested in identifying rare marker species, the threshold may be lowered to include more predictions, even those with lower confidence levels. Conversely, if the focus is on relatively high-precision identification, the threshold may be raised to increase the possibility that only reliable predictions aligning with such identification are included in the filtered set.

In an embodiment, a hierarchical filtering approach may be employed, where predictions are first filtered based on a generic confidence threshold, followed by additional filtering based on species-specific thresholds or other criteria. Such a hierarchical filtering approach may allow for fine-tuning the filtering process to account for variations in model performance across different species or taxonomic groups.

In embodiments, if an ensemble of machine learning models are utilized, the filtered set of predictions may be generated by aggregating the predictions from each model, potentially using weighted averaging or other consensus-building techniques. Such an approach may leverage the strengths of different models and improve the overall accuracy and reliability of the filtered set. Additionally, an interactive interface where users may manually adjust the confidence threshold or apply additional filtering criteria based on their specific needs and preferences may be provided. Such an interactive interface may allow for greater flexibility and control over the composition of the filtered set, enabling users to tailor the analysis to their specific research objectives.

In the above ways, generating a filtered set of predictions comprising the prediction and a plurality of other predictions for other images filtered based on the confidence level threshold may enhance the efficiency and accuracy of biostratigraphic analysis, enabling faster and more informed decision-making in hydrocarbon exploration and production activities. The focus on generating a manageable and informative dataset of embodiments of the present disclosure underscores their commitment to empowering users to extract potentially useful insights from the amounts of data generated by automated microscope systems.

Additional steps may be performed after the filtered set of predictions is generated. In an embodiment, the prediction is removed from the filtered set of predictions when the image is classified as not depicting fossils. This step may aid in improving the accuracy and reliability of the generated biostratigraphic analysis. While the machine learning model is trained to identify and classify calcareous nannofossils, it may occasionally misinterpret other objects or features within an image as fossils. These could include air bubbles, debris, or other artifacts introduced during sample preparation or image acquisition. Such misidentifications, sometimes referred to as “junk,” may clutter the dataset and introduce noise into the analysis.

To address this challenge, a mechanism to actively identify and remove such erroneous predictions may be incorporated. The machine learning model, in addition to predicting the presence of specific nannofossil species, also assesses the likelihood that an image depicts any fossil at all. If the confidence of the model in the presence of a fossil falls below a certain threshold or if the image is explicitly classified as not depicting fossils, the corresponding prediction is removed from the filtered set. This filtering step may serve multiple purposes. First, it may enhance the accuracy of the dataset by reducing or eliminating false positives, improving the possibility that primarily genuine fossil identifications are retained for further analysis. Second, it may improve the workflow by reducing the number of images that require manual review and validation by the user. By focusing on a curated set of high-confidence predictions, the user may dedicate their time and expertise to sufficiently relevant and informative data.

The removal of non-fossil predictions may be achieved through various approaches, including training the machine learning model on non-fossil examples, general confidence thresholding, and user validation and feedback. For example, the machine learning model may be explicitly trained on a set of images that depict common non-fossil objects or artifacts encountered in the microscopic analysis of well slides. This training may enable the model to learn to distinguish between true fossils and potential sources of confusion, improving its ability to accurately classify images. Further, in addition to filtering based on species-specific confidence thresholds, a general threshold may be applied to all predictions. If the overall confidence of the model in the presence of a fossil in an image falls below this threshold, the prediction may be flagged for removal, regardless of the specific species identification. Additionally, an interface for users to manually flag predictions as “junk” or non-fossils may be provided. This feedback may then be incorporated into the training process to further refine the ability of the model to discriminate between fossils and non-fossils, potentially leading to continuous improvement in its performance.

In an embodiment, a quantile filter is applied to the filtered set of predictions. This step may further refine the dataset and enhance the efficiency of biostratigraphic analysis by removing a portion of the lower-confidence predictions while preserving the overall distribution and relative abundance of species within the sample.

The quantile filter operates by setting a threshold based on the distribution of confidence levels within the filtered set of predictions. For example, a 90th percentile quantile filter would retain only the top 10% of predictions with the highest confidence levels, while discarding the remaining 90%. This approach enables the removal of a substantial portion of the lower-confidence data without completely eliminating any particular species or skewing the overall representation of the fossil assemblage.

The application of a quantile filter may be beneficial in scenarios where the machine learning model generates a large number of predictions, some of which may have relatively low confidence levels. This may occur when dealing with complex or poorly preserved samples or when the model encounters nannofossil species that are not well-represented in the training library.

By removing a portion of these lower-confidence predictions, the quantile filter helps to reduce noise and uncertainty, improve workflow, and/or maintain relative abundance. For example, when using a quantile filter, the filtered dataset becomes more focused and reliable, reducing the potential for misinterpretations due to erroneous or uncertain identifications. Additionally, the reduced data volume may allow for faster and more efficient analysis, enabling users to focus their attention on sufficiently confident and informative predictions. Further, the quantile filter may preserve the overall distribution of species within the sample, improving the chances that even less abundant taxa are represented in the filtered dataset, which may be useful for accurate biostratigraphic interpretation.

The specific quantile threshold used may vary depending on the desired level of confidence and the characteristics of the sample being analyzed. In some embodiments, different quantile thresholds may be applied to different groups of species, such as marker species versus background species, to further refine the filtering process.

In an embodiment, the filtered set of predictions is further filtered based on the age range of the sample. This step serves to enhance the accuracy and relevance of the biostratigraphic analysis by reducing or eliminating predictions that are inconsistent with the known or estimated age of the geological formation from which the sample was obtained.

The relative age range of a sample may be determined by biostratigraphic age dating. Once the age range of the sample is established, the predictions may be filtered by removing those that correspond to nannofossil species whose known stratigraphic ranges do not overlap within the broad age range of the sample. This filtering process may aid in reducing misclassifications, refining the dataset, and enhancing efficiency. For example, the machine learning model, despite its training, may occasionally misidentify nannofossils, particularly when dealing with poorly preserved specimens or taxa with subtle morphological differences. Age-based filtering may help to eliminate such misclassifications by removing predictions that are stratigraphically inconsistent. Additionally, the filtered set of predictions may become more focused and relevant to the specific age of the sample, facilitating more accurate and meaningful biostratigraphic interpretations. Further, by removing irrelevant predictions, the data analysis process may be streamlined, allowing users to focus on sufficiently pertinent information for age determination and correlation.

The implementation of age-based filtering may be further refined through various approaches, such as confidence-weighted filtering, marker species exemption, or dynamic age window adjustment. For example, weights may be assigned to predictions based on their confidence levels and the degree of overlap between their stratigraphic ranges and the age range of the sample. This weight assignment may allow for a more nuanced filtering process that prioritizes high-confidence predictions that are also stratigraphically consistent. Additionally, certain marker species, useful for biostratigraphic correlation, may be exempted from the age-based filtering, even if their known ranges do not perfectly align with the estimated age of the sample. Such exemption may improve the chances that these key taxa are not inadvertently excluded from the analysis. Further, the age range used for filtering may be dynamically adjusted based on new information or insights gained during the analysis. This may allow for iterative refinement of the dataset and more accurate interpretations.

In an embodiment, a subset of the filtered set of predictions is presented to a user via a user interface. The subset is selected based on confidence levels associated with predictions in the filtered set of predictions.

The automated analysis of microscopic fossil images generates a relatively large amount of data, including predictions about the identity of nannofossils present in each image. While filtering based on confidence thresholds helps to refine this data, the sheer volume of remaining predictions may still be overwhelming for a user to review and interpret efficiently.

To address this challenge, a mechanism for presenting only a curated subset of the filtered predictions to the user through a user interface may be utilized. This subset may be selected based on the confidence levels associated with each prediction, prioritizing those with lower confidence levels that may require further scrutiny or validation by the user.

By presenting a focused subset of predictions, the embodiment aims to streamline the user experience, prioritize uncertain identifications, and facilitate efficient decision-making. For example, instead of being inundated with a large number of predictions, the user may be presented with a manageable subset that requires their immediate attention. This compartmentalization may allow for a more efficient and targeted review of the data. Additionally, by focusing on predictions with lower confidence levels, the embodiment guides the user toward potential areas of ambiguity or misclassification, enabling them to apply their expertise to confirm or correct the output of the model. Further, by presenting relatively more relevant and potentially impactful predictions, the system empowers the user to make informed decisions regarding further analysis, data collection, or interpretation of the biostratigraphic results.

The user interface may take various forms, such as a graphical display showcasing the images and their associated predictions, a tabular listing of predictions, or an interactive interface allowing navigation, zooming, and feedback provision.

The subset of the filtered set of predictions may include allowing the user to bulk validate the subset of predictions. The large volume of image data and predictions generated by automated biostratigraphic analysis may necessitate efficient validation mechanisms. Bulk validation may enable the user to review and confirm or correct multiple predictions simultaneously, thereby potentially expediting the validation process.

This bulk validation functionality, which is discussed in more detail with respect to FIG. 4, may be implemented within the user interface, allowing the user to select a group of predictions based on various criteria, such as confidence level, sample depth, or taxonomic group, and apply a single validation action to all selected predictions. The bulk validation functionality may streamline the review process, particularly for larger datasets or when dealing with repetitive or easily recognizable patterns.

In an embodiment, the filtered set of predictions is searched via a search interface based on at least one search criterion. The ability to efficiently search and retrieve specific information from the dataset of filtered predictions may be useful for effective biostratigraphic analysis. A search interface within the user interface may empower users to quickly locate and access relevant data based on various search criteria.

The user interface may allow for searching the filtered set of predictions based on at least one of: fossil species, genus, confidence level, sample depth, and multiple predictions. For example, searching by fossil species or genus may allow users to focus on specific taxa of interest, aiding in the identification of marker species or the assessment of biodiversity. Searching by confidence level may enable users to filter predictions based on their reliability, prioritizing those with high confidence or focusing on those with lower confidence for further validation. Additionally, searching by sample depth may allow for targeted analysis of specific stratigraphic intervals within the sample, facilitating correlation and age determination. Further, searching by multiple predictions may enable complex queries, such as searching for images where the model has predicted the co-occurrence of multiple species, aiding in the identification of characteristic fossil assemblages.

The search interface, coupled with the ability to sort and filter predictions, may provide users with a tool for navigating and interrogating the dataset, extracting useful insights for biostratigraphic interpretation and decision-making in hydrocarbon exploration and production.

In an embodiment, displays of metadata associated with the image and a plurality of images separate from the image are created. This step may enhance the ability of a user to interpret and interact with the relatively large amount of data generated by automated biostratigraphic analysis. Metadata, in this context, refers to additional information associated with each image, such as the predicted fossil species, confidence levels, abundance counts, size distributions, and model performance metrics.

By creating visual displays of this metadata, users may gain a deeper understanding of the data and the performance of the machine learning model. For example, these displays may provide insights into fossil abundance and diversity, model confidence and accuracy, size distributions, and model performance metrics. The specific types of metadata displays may vary depending on the needs and preferences of the user. Some examples include bar charts, histograms, scatter plots, heatmaps, and interactive tables.

Further, the metadata displays may be linked to the original images, allowing users to easily navigate between the visual representation of the fossils and the associated metadata. This interactive functionality may enhance the user experience and facilitate a more comprehensive and efficient analysis of the data.

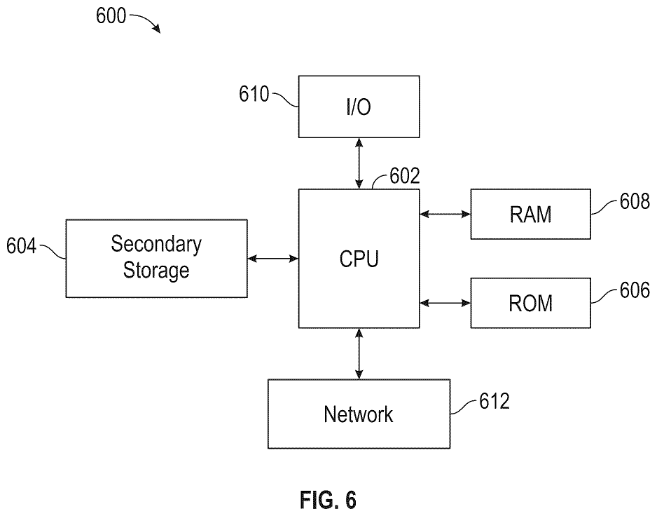

Referring now to FIG. 6, a computer system 600 suitable for implementing one or more embodiments disclosed herein is shown. Any of the systems and methods disclosed herein can be carried out (e.g., entirely or partially) on a computer or other device comprising a processor (e.g., a desktop computer, a laptop computer, a tablet, a server, a smartphone, or some combination thereof). The computer system 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips.

It is understood that by programming and/or loading executable instructions onto the computer system 600, at least one of the CPUs 602, the RAM 608, and the ROM 606 are changed, transforming the computer system 600 in part into a particular machine or apparatus having the novel functionality taught by the present disclosure. Thus, the RAM 608 and/or the ROM 606 may comprise a non-transitory machine-readable (or computer-readable) medium that may include instructions (which may be referred to herein as machine-readable instructions) that are executable by CPU 602 to provide functionality to computer system 600. Thus, in some embodiments, a machine-readable instructions stored on a memory may be executed on a processor, so as to configured the processor to carry out some or all of the features of the methods described herein (e.g., method 500).

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware (for example in an application-specific integrated circuit (ASIC), or a field-programmable gate array (FPGA)) because for large production runs the hardware implementation may be less expensive than the software implementation. Sometimes a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 600 is turned on or booted, the CPU 602 may execute a computer program or application. For example, the CPU 602 may execute software or firmware stored in the ROM 606 or stored in the RAM 608. In some cases, on boot and/or when the application is initiated, the CPU 602 may copy the application or portions of the application from the secondary storage 604 to the RAM 608 or to memory space within the CPU 602 itself, and the CPU 602 may then execute instructions of which the application is comprised. In some cases, the CPU 602 may copy the application or portions of the application from memory accessed via the network connectivity devices 612 or via the I/O devices 610 to the RAM 608 or to memory space within the CPU 602, and the CPU 602 may then execute instructions of which the application is comprised. During execution, an application may load instructions into the CPU 602, for example load some of the instructions of the application into a cache of the CPU 602. In some contexts, an application that is executed may be said to configure the CPU 602 to do something, e.g., to configure the CPU 602 to perform the function or functions promoted by the subject application. When the CPU 602 is configured in this way by the application, the CPU 602 becomes a specific purpose computer or a specific purpose machine.

The secondary storage 604 is typically comprised of one or more disk drives or tape drives and is used for non-volatile storage of data and as an over-flow data storage device if RAM 608 is not large enough to hold all working data. Secondary storage 604 may be used to store programs which are loaded into RAM 608 when such programs are selected for execution. The ROM 606 is used to store instructions and perhaps data which are read during program execution. ROM 606 is a non-volatile memory device which typically has a small memory capacity relative to the larger memory capacity of secondary storage 604. The RAM 608 is used to store volatile data and perhaps to store instructions. Access to both ROM 606 and RAM 608 is typically faster than secondary storage 604. The secondary storage 604, the RAM 608, and/or the ROM 606 may be referred to in some contexts as computer readable storage media and/or non-transitory computer readable media.

I/O devices 610 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 612 may take the form of modems, modem banks, Ethernet cards, Omni-Path Architecture (OPA), InfiniBand (IB), universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 612 may enable the processor 602 to communicate with the Internet or one or more intranets. With such a network connection, it is contemplated that the processor 602 may receive information from the network, or may output information to the network (e.g., to an event database) in the course of performing the methods described herein. Such information, which is sometimes represented as a sequence of instructions to be executed using processor 602, may be received from and outputted to the network, for example, in the form of a computer data signal embodied in a carrier wave.

Such information, which may include data or instructions to be executed using processor 602 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 602 executes instructions, codes, computer programs, scripts which it accesses from hard disk, floppy disk, optical disk, solid state drives (SSD) (these various disk-based systems may all be considered secondary storage 604), flash drive, ROM 606, RAM 608, or the network connectivity devices 612. While only one processor 602 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 604, for example, hard drives, floppy disks, optical disks, and/or other device, the ROM 606, and/or the RAM 608 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 604, to the ROM 606, to the RAM 608, and/or to other non-volatile memory and volatile memory of the computer system 600. The processor 602 may process the executable instructions and/or data structures in part by directly accessing the computer program product, for example by reading from a CD-ROM disk inserted into a disk drive peripheral of the computer system 600. Alternatively, the processor 602 may process the executable instructions and/or data structures by remotely accessing the computer program product, for example by downloading the executable instructions and/or data structures from a remote server through the network connectivity devices 612. The computer program product may comprise instructions that promote the loading and/or copying of data, data structures, files, and/or executable instructions to the secondary storage 604, to the ROM 606, to the RAM 608, and/or to other non-volatile memory and volatile memory of the computer system 600.

In some contexts, the secondary storage 604, the ROM 606, and the RAM 608 may be referred to as a non-transitory computer readable medium or a computer readable storage media. A dynamic RAM embodiment of the RAM 608, likewise, may be referred to as a non-transitory computer readable medium in that while the dynamic RAM receives electrical power and is operated in accordance with its design, for example during a period of time during which the computer system 600 is turned on and operational, the dynamic RAM stores information that is written to it. Similarly, the processor 602 may comprise an internal RAM, an internal ROM, a cache memory, and/or other internal non-transitory storage blocks, sections, or components that may be referred to in some contexts as non-transitory computer readable media or computer readable storage media. At least some, if not all, of the steps or “blocks” of method 500 shown in FIG. 5, may be executed by the computer system 600 shown in FIG. 6, although it is to be understood that at least some of the steps of method 500 may be executed by systems other than computer system 600.

While several embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of this disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

As such, the preceding discussion is directed to various exemplary embodiments. However, one skilled in the art will understand that the examples disclosed herein have broad application, and that the discussion of any embodiment is meant only to be exemplary of that embodiment, and not intended to suggest that the scope of this disclosure, including the claims, is limited to that embodiment.

Certain terms are used throughout the preceding description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the preceding discussion and the claims, the terms “including” and “comprising” are used in an open-ended fashion and thus should be interpreted to mean “including, but not limited to... .” Also, the term “couple” or “couples” is intended to mean either an indirect or direct connection. Thus, if a first device couples to a second device, that connection may be through a direct engagement between the two devices or through an indirect connection established via other devices, components, nodes, and connections. In addition, as used herein, the terms “axial” and “axially” generally mean along or parallel to a particular axis (e.g., a central axis of a body or a port), while the terms “radial” and “radially” generally mean perpendicular to a particular axis. For instance, an axial distance refers to a distance measured along or parallel to the axis, and a radial distance means a distance measured perpendicular to the axis. Any reference to up or down in the description and the claims is made for purposes of clarity, with “up,” “upper,” “upwardly,” “uphole,” or “upstream” meaning toward the surface of the borehole and with “down,” “lower,” “downwardly,” “downhole,” or “downstream” meaning toward the terminal end of the borehole, regardless of the borehole orientation.

As used herein, the terms “approximately,” “about,” “substantially,” and the like mean within 10% (i.e., plus or minus 10%) of the recited value unless otherwise stated. Thus, for example, a recited angle of “about 80 degrees” refers to an angle ranging from 72 degrees to 88 degrees. Where single components, apparatuses, or systems are described as performing functions, multiple such components, apparatuses, or systems may implement the functions.

Thus, while several embodiments have been provided, the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. Likewise, where single components, apparatuses, or systems are described as performing functions, multiple such components, apparatuses, or systems may implement the functions.

What is claimed is:

1. A method, comprising:
preparing a slide with a rock sample;
capturing, with a slide scanner, a plurality of images of the slide in a non-continuous scanning pattern until a predetermined coverage percentage of the slide is captured, wherein each image is a block of a predetermined block dimension;
generating a prediction for each of the images, wherein the prediction for an image includes an identification of a fossil of a species present in the image and a confidence level associated with the identification;
filtering the images based on a confidence level threshold for the confidence level associated with the identified species; and
generating a filtered set of images comprising the prediction for each image.

2. The method of claim 1, wherein in the non-continuous scanning pattern, a first image is of a first location of the slide, and a second image is of a second location of the slide, wherein the second location differs from the first location by a random amount in an x-axis of the slide, a random amount in a y-axis of the slide, or a random amount in both the x-axis and the y-axis of the slide.

3. The method of claim 1, further comprising setting a predetermined focal density in the slide scanner before capturing the images.

4. The method of claim 1, further comprising setting a predetermined objective magnification level in the slide scanner before capturing the images.

5. The method of claim 1, further comprising setting a predetermined scan time in the slide scanner before capturing the images.

6. The method of claim 1, further comprising removing an image from the filtered set of images when the image is classified as not depicting fossils.

7. The method of claim 1, further comprising applying a quantile filter to the filtered set of predictions.

8. The method of claim 1, further comprising filtering the filtered set of images based on an age range of the sample.

9. The method of claim 1, further comprising presenting a subset of the filtered set of images to a user via a user interface, wherein the subset is selected based on confidence levels associated with predictions in the filtered set of images.

10. The method of claim 9, further comprising receiving a bulk validation instruction from a user based on the presented subset.

11. The method of claim 9, further comprising searching the filtered set of images based on at least one search criterion, wherein the user interface provides an option for searching the filtered set of images based on at least one of: fossil species, fossil genus, confidence level, sample depth, and multiple predictions.

12. The method of claim 1, further comprising creating displays of metadata associated with the image and a plurality of images separate from the image.

13. A system, comprising:
a slide scanner; and
an electronic device coupled to the slide scanner and comprising:
one or more processors; and
a memory coupled to the one or more processors and storing instructions that, when executed by the one or more processors, cause the electronic device to be configured to:
cause the slide scanner to capture a plurality of images of a slide prepared with a rock sample in a non-continuous scanning pattern until a predetermined coverage percentage of the slide is captured, wherein each image is a block of a predetermined block dimension;
generate a prediction for each of the images, wherein the prediction for an image includes an identification of a fossil of a species present in the image and a confidence level associated with the identification;
filter the images based on a confidence level threshold for the confidence level associated with the identified species; and
generate a filtered set of images comprising the prediction for each image.

14. The system of claim 13, wherein in the non-continuous scanning pattern, a first image is of a first location of the slide, and a second image is of a second location of the slide, wherein the second location differs from the first location by a random amount in an x-axis of the slide, a random amount in a y-axis of the slide, or a random amount in both the x-axis and the y-axis of the slide.

15. The system of claim 13, wherein the electronic device is further configured to set a predetermined focal density in the slide scanner before capturing the images.

16. The system of claim 13, wherein the electronic device is further configured to set a predetermined objective magnification level in the slide scanner before capturing the images.

17. The system of claim 13, wherein the electronic device is further configured to set a predetermined scan time in the slide scanner before capturing the images.

18. The system of claim 13, wherein the electronic device is further configured to remove an image from the filtered set of images when the image is classified as not depicting fossils.

19. The system of claim 13, wherein the electronic device is further configured to filter the filtered set of images based on an age range of the sample.

20. A non-transitory computer-readable medium storing instructions that, when executed by one or more processors of an electronic device, cause the electronic device to be configured to:
cause a slide scanner to capture a plurality of images of a slide prepared with a rock sample in a non-continuous scanning pattern until a predetermined coverage percentage of the slide is captured, wherein each image is a block of a predetermined block dimension;
generate a prediction for each of the images, wherein the prediction for an image includes an identification of a fossil of a species present in the image and a confidence level associated with the identification;
filter the images based on a confidence level threshold for the confidence level associated with the identified species; and
generate a filtered set of images comprising the prediction for each image.
